(19) United States
(12) Patent Application Publication
(10) Pub. No.: US 2016/0376007 A1
(43) Pub. Date: Dec. 29, 2016

(54) Aircraft Seat with Seating and Reclining Positions

(71) Applicant: Peak Technology GmbH, Holzhausen (AT)

(72) Inventor: Daniel Meindlhumer, Prambachkirchen (AT)

(21) Appl. No.: 15/190,210

(22) Filed: Jun. 23, 2016

(30) Foreign Application Priority Data
Jun. 26, 2015 (DE) 102015110369.9

(51) Int. Cl. B64D 11/06

(52) U.S. Cl. CPC B64D 11/064; B64D 11/0698; B64D 11/0643; B64D 11/0644

(57) ABSTRACT

An aircraft seat with a support structure (22), a first seating surface (26) and a first back piece (30), the lower area of which is connected to the support structure (22) so as to be capable of swiveling. The seat permits upright sitting of a person in a first position of the first back piece (30). The first back piece (30) can be put down in such a way that it runs horizontally over the first seating surface (26) in a second position. The back side of the first back piece (30) forms a second seating surface (38). A second back piece (40) is arranged between the support structure (22) and the first back piece so as to be capable of being folded out or unfolded so that the seat (20) forms a recliner for the person in the second position of the first back piece (30).

### CROSS REFERENCE TO RELATED APPLICATIONS

This application claims the priority of DE 102015110369.9 filed on 2015 Jun. 26; this application is incorporated by reference herein in its entirety.

### BACKGROUND

Field of the Invention

The invention relates to a seat for an aircraft. In particular, the invention relates to a seat for an aircraft with an adjustable seat position.

Background of the Invention

So-called “rest facilities” are commonly found in commercial aircraft for the carriage of passengers, especially for crew members. These “rest facilities” can be understood to mean a seat or recliner with footrests and/or leg supports that makes resting or sleeping possible in the aircraft or aircraft cabin. The use of these rest facilities can make it possible, as an example, to adapt the flight service time periods of the crew, which can involve economic benefits for the airline, among other things. The “rest facilities” are frequently subject to specific regulations and requirements and can be divided up into classes for this, as an example. A seat in class 2 could be a seat in the aircraft cabin, for example, that can be subjected to the requirements of having a tilt of the backrest of at least 45 degrees with respect to a vertical position, a minimum spacing of 137.5 cm and a seat width of at least 50 cm, in addition to further criteria. In addition, a leg support and/or footrest can be required.

Seats of that type frequently have two positions that the seat can be put into when it is used: an upright “TTL” seat position for taxiing, takeoff and landing, as well as the “rest” position, for a crew member to recline or sleep during the cruise flight, for instance. Those types of seats, known in the prior art, frequently also have a compartment for storing a mandatory emergency kit and a tray table.

An “Ultra High Comfort Attendant Seat” of the company UTC Aerospace Systems is known, for example, that brings about a tilt of the backrest by swiveling out a lower part of the backrest in the vertical direction and holding the tilted backrest in this position via a support mechanism. This principle can have adverse characteristics with regard to a reclining position of the person, though, as well as with regard to comfort, handling, stability and space requirements.

### SUMMARY

Embodiments of the invention can advantageously make a vertical swiveling of a back piece of an aircraft possible over a larger angle with simple handling and stability; greater flexibility and lower costs in flight operations can be achieved because of that. The invention described below is based on the following considerations, among others. An angle of tilt of a few degrees can in fact be achieved with respect to a vertical position via swiveling around a pivot axle positioned at the upper end of a back piece in accordance with the prior art, but unwanted effects, for instance stability problems and an increase in weight because of more complex support mechanisms, greater forces and an unfavorably higher position of the reclining surface over the floor caused by the angular movement, arise in the case of larger angles, especially in the case of angles of 30 degrees or more, for instance, due to the limited space. It would therefore be desirable to create a more stable structure that, in particular, allows positions with an angle of tilt of the back piece of 45 degrees or more with respect to a vertical position and that, moreover, has a space and weight-saving construction.

An aircraft seat is therefore proposed that has a support structure and a first seating surface that essentially extends horizontally and that is attached to the support structure. Furthermore, a first back piece is provided, wherein the first back piece is attached to the support structure so as to be capable of swiveling in a vertical plane around a back-piece pivot axle arranged in the area of the first seating surface so that the first back piece is positioned vertically and forms, in a first position together with the first seating surface, a seat for upright sitting of a person and, in a second position, extends horizontally over the first seating surface. The back side of the first back piece turned towards the support structure is designed in such a way that at least a partial area of the back side forms a second seating surface in the second position. Moreover, a second back piece is provided that is arranged between the support structure and the first back piece and that is attached to the support structure at one end and obliquely attached at its other end to the first back piece so that the second back piece forms, together with the second seating surface, a recliner for the person in the second position.

### DETAILED DESCRIPTION

The fact that a tilt of the back piece of 45 degrees or more with respect to a vertical position can be made possible, especially in the available space that is usually limited in aviation of all areas, can be regarded as an advantage of this aircraft seat. Further, the various seating positions can be changed with a few simple steps and can eliminate the need to instruct the relevant person, for instance flight attendants, because of their simplicity. On top of that, the available space can be used in an optimal way with space-saving positioning capabilities, because both sides of the first back piece, or backrest, can be functionally used.

A support structure can be understood, as an example, to mean a supporting structure arranged in an interior area of an aircraft, for instance a cabin wall, a partition wall or a similar rigid arrangement that is sufficiently stable and that has a fixed structure offering sufficient stability to suspend or attach an aircraft seat. A horizontal extension can be understood to mean a direct that essentially runs in parallel with the floor. That can be the floor of an aircraft cabin, for example. Analogously, a vertical extension describes a direction essentially running perpendicular to this floor. A back piece can be a well-known backrest or back support that is suitable for supporting a sitting or reclining person on the respective position.

The first back piece horizontally arranged in the second position can also be supported on the first seating surface in one example. This can have the advantage that no support, or a small amount of support, of the distant end of the first back piece is required with respect to the floor, because fewer forces act in the area of the support structure due to increased stability. The back side of the first back piece can, as an example, be designed with suitable padding and/or coating so that a person can sit or recline comfortably on it.

The second back piece offers, in other words, a surface in the second position that is supported on the support structure, on the one hand, and on the first back piece, on the other hand. The most diverse solutions are conceivable here, for instance rigid structures that can be connected via joints, for instance, but fabrics made of textiles or other fibers with sufficient strength are also conceivable, among other things. Moreover, the second back piece can be designed to be stowed away between the support structure and the first back piece in such a way that it saves as much space as possible. The oblique attachment of the second back piece to the first back piece means that the second back piece has a tilt with respect to the first back piece of significantly less than 90 degrees vis-a-vis a vertical position, so 45 degrees, for instance, in the direction of the support structure. A recliner can be understood to mean a seat for one person whose backrest in a sitting/reclining position is arranged with a tilt deviating substantially from an upright or vertical position. This position is supposed to make stronger horizontal support of a person possible with respect to an upright sitting position for the purpose of rest and relaxation.

In one embodiment, the second back piece has first and second flat segments; the first flat segment is attached to the support structure so as to be capable of swiveling around a first segment pivot axle and is connected to a second flat segment so as to be capable of swiveling via a second segment pivot axle on a common edge. The second flat segment is attached to the back side of the first back piece so as to be capable of swiveling around a third segment pivot axle; the two segments are designed in such a way, and the segment pivot axles are arranged in parallel with one another in such a way, that the first segment and the second segment are arranged in back of each other in a plane in a second position of the first back piece.

The fact that a mechanically stable and space-saving design of the second back piece is possible is regarded as an advantage of this embodiment. The swiveling connection can be provided via hinges or similarly suitable joints, for instance. The individual segments can simultaneously be actuated or moved via the swiveling of the first back piece. In one example, three or more segments are used instead of two segments. It is likewise conceivable that additional folding mechanisms with different, additional pivot axles can be used, for instance to make optimal use of the space between the first back piece and the support structure. The arrangement of the two segments in back of one another in one plane is supposed to make it clear that the second back piece should be suitable for serving as a backrest or back support for a person.

In one embodiment, a position of the two segments of the second back piece can be fixed in place relative to one another in the second position of the first back piece. In other words, one configuration of the second back piece can be latched in place. That can be done, for instance, by arranging a latchable mechanism on the pivot axle that can either automatically engage in a latched position or that can also be manually set or fixed in place by the person. In one example, the aircraft seat has a combined lever mechanism that permits latching of the first back piece and latching of the two segments. The advantage of the latching is reliable stability and prevention of an undesired movement of the segments, which could, in particular, be caused by the movement of the aircraft itself, for instance because of turbulence.

In one embodiment, a length of the first segment and of the second segment and the arrangement of the segment pivot axles of the second back piece are chosen in such a way that the first flat segment is arranged essentially in parallel next to the second flat segment in the first position of the first back piece. That can have the advantage that space between the support structure and the first back piece is used as effectively, as possible, so only a minimal amount of additional space is required to stow away the second back piece. In other words, the first and second segments can, for instance, be arranged in parallel directly on the back side of the first back piece.

In one embodiment, an angle between a line perpendicular to the plane of the first back piece and the plane of the first and second segments is between 45 and 50 degrees in the second position. Assuming that an angle of 0 degrees corresponds to an upright sitting position, this tilt means that there is roughly a half-reclining position of a backrest. Certain minimum tilts, for instance 45 degrees for seats in class 2, are required in aviation, as an example, within the framework of regulations for flight operations. The fact that angular ranges of that type are made possible despite the space limitations and that legal requirements can in turn be fulfilled because of this can also be regarded as an advantage.

In one embodiment, a support unit is arranged on an end of the first back piece distant from the support structure that is designed to support the first back piece in the second position with respect to a floor. This can mean that there is the advantage of increased stability, because strong forces can arise under certain circumstances from the attachment of the first back piece to one area of the support structure in combination with the weight of the person on the connection between the first back piece and the support structure. That can be reduced with the additional support point. A support unit of that type can be attached so as to fold out or be pulled out in an interior area, for instance, or externally attached to the first back piece or, in a further example, can be attached as a separate element.

In accordance with one embodiment, the aircraft seat has a foot piece that can be attached to the second seating surface at the end of the first back piece that is distant from the support structure or that can be folded out and, in accordance with a further embodiment, can be removed and put into storage in an interior area of the first seating surface. An enlarged length of the sitting or reclining surface, so that the person will get space on the second seating surface and the foot piece with the entire length of the legs, can be an advantage of this embodiment. Stowing the foot piece away in the first seating surface, for instance underneath it, can make additional space savings possible. The foot piece can, in accordance with one example, be attached in a push-in fashion to the first back piece. In another example, the foot piece is designed to fold and/or be capable of integration into the first back piece.

In one embodiment, the first seating surface can be detached from the support structure and attached as a foot piece to the first back piece. This is based on the following considerations. In the second position of the first back piece, the first seating surface is located on the bottom of it and can, if necessary, serve as a support for the first back piece. If this is not the case, the first seating surface can be released from the support structure, for instance via a suitable mechanism, and be attached or fastened as a foot piece to the distant end of the first back piece. Double use of the first seating surface and consequently space savings and a possible reduction in weight of the aircraft seat can be regarded as an advantage here.

In accordance with one embodiment, the first seating surface can be swiveled in a first position of the first back piece from a horizontal position to a vertical position and connected to an armrest in such a way that it likewise swivels from a horizontal position into a vertical position when the first seat is swiveled into the vertical position. In other words, the first seating surface can be lifted up in a first position and this consequently reduces horizontal space requirements of the aircraft seat. Furthermore, an armrest that has been put down will swivel into a closed-up or lifted-up position via a mechanical connection when the first seating surface is lifted up. That can have the advantage that both of the swivel functions can be completed with only one action.

### BRIEF DESCRIPTION OF THE DRAWINGS

Examples of the invention will be described in detail below with reference to the enclosed drawings. Neither the description nor the drawings should be interpreted in a limited way as being the invention.

FIG. 1 shows a longitudinal section of two aircraft cabins with positions of aircraft seats for flight attendants.

FIG. 2A shows an aircraft seat as per the invention in a first position with a lifted-up first seating surface and lifted-up armrests.

FIG. 2A shows an aircraft seat as per the invention in a first position (“TTL position”) with a first seating surface that has been put down and armrests that have been put down.

FIG. 2C shows an aircraft seat as per the invention in a second position (“rest position”) with a foot piece.

FIGS. 3A to 3D show adjustment steps of an aircraft seat as per the invention from a first position into a second position of the first back piece.

FIG. 4 shows an aircraft seat as per the invention with a stow-away possibility for the foot piece on the first seating surface.

The drawings are only schematic and not true to scale. Identical or similar parts are given the same reference numbers as a general principle.

### DETAILED DESCRIPTION OF THE PREFERRED EMBODIMENTS

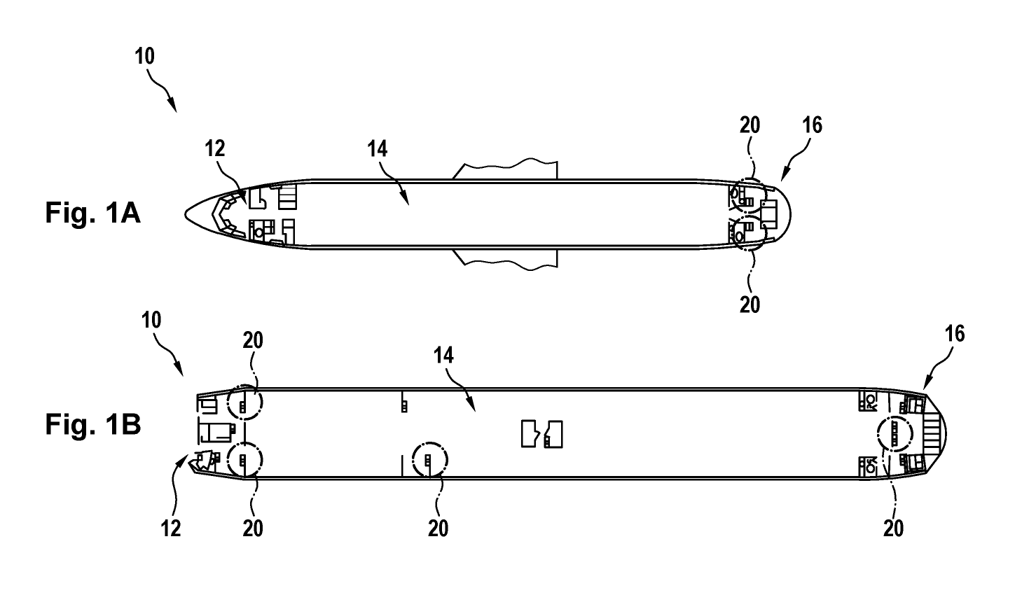

FIG. 1A shows a longitudinal section of aircraft cabins of two different commercial aircraft 10 for passenger transport with a cockpit area 12 and a cabin 14. The examples that are shown are only supposed to illustrate a structure of aircraft cabins 14 of that type in the form of an example; the aircraft seat 20 that is described can be used, as a general principle, in all vehicles, particularly in aircraft. Flight attendants, who could mainly be in the area of the cabin 14, are typically members of the crew in passenger aircraft. A seat 20 that is usually physically separated from the passenger seats is provided for the flight attendants during the start, landing and taxiing. The areas in the cabin 14 in which one or more seats 20 of that type are provided are marked with a circle in each case. Although these seats 20 for flight attendants are frequently located in a rear area 16 of the aircraft 10 in smaller aircraft 10, these seats can also be frequently distributed in the cabin 14 in larger aircraft 10. The seat 20 can also be arranged in the direction of flight or against the direction of flight here, for example. The seats 20 can be arranged on cabin partition walls for more stable anchoring or physical separation.

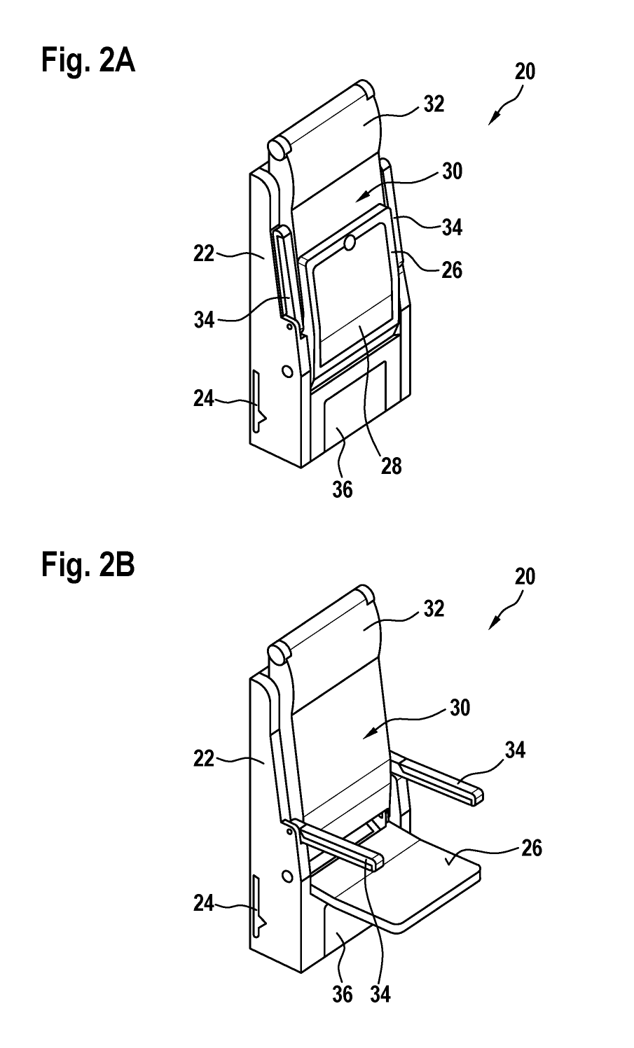

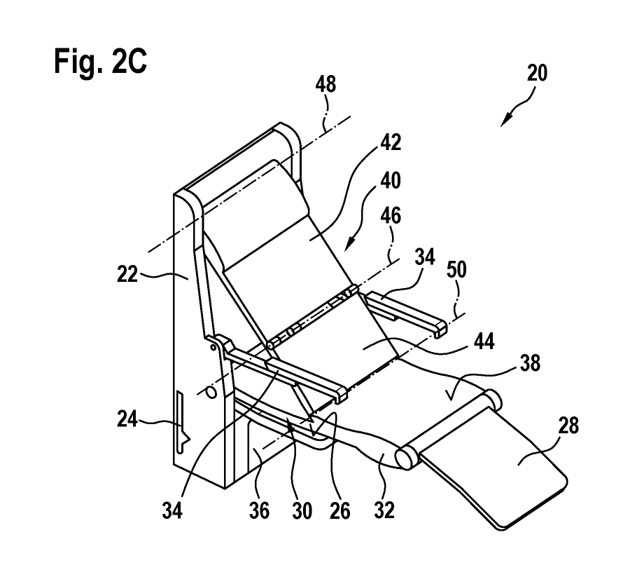

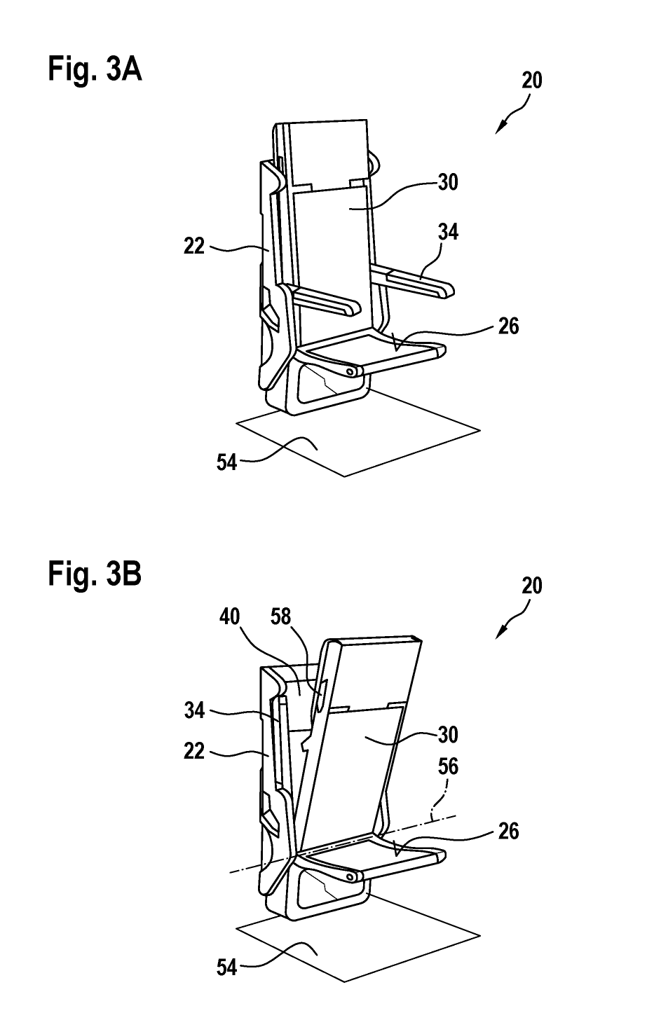

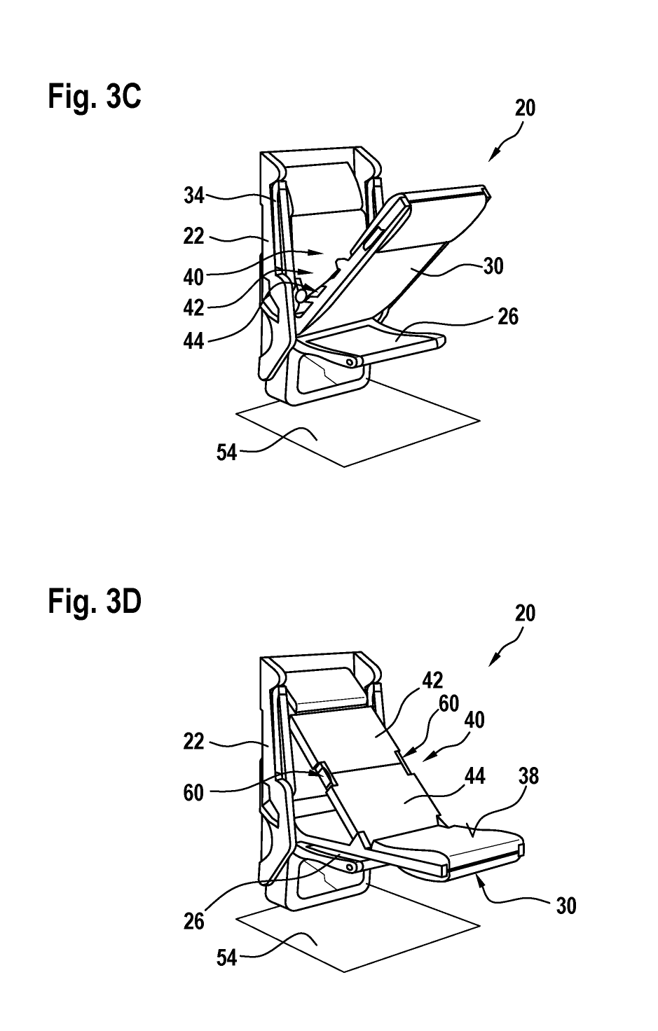

FIGS. 2A to 2C show an aircraft seat 20 as per the invention in three different usage situations. In FIG. 2A, the aircraft seat 20 is shown in a closed-up state as would be found, for instance, during exit and entry or loading and unloading of the aircraft 10. A space-saving arrangement of that type is necessary in most cases, because seats 20 of that type are usually located in the area of doors, emergency exists or passageways that are to be kept clear at certain points in time. The seat has a support structure 22 that can be designed in the form of a metal and/or plastic frame, for instance. The support structure 22 has sufficient stability to be firmly connected to the cabin 14, for example with a cabin floor (see FIGS. 3A to 3D) or an intermediate wall or partition wall in the cabin 14, and to absorb the forces caused by a person sitting or reclining. A push-in compartment 24 for an attachable table (tray table) is provided in the lower area of the seat 20.

A first seating surface 26 is provided on the support structure 22 that can be attached, for example, via a suspension that can be swiveled, joints, hinges or similar types of things. The bottom of the first seating surface 26 has a holder for a foot piece 28. This can have the advantage that no additional storage space is required to stow away the foot piece 28. A first back piece 30, which is likewise attached to the support structure 22 so as to be able to swivel, is provided horizontally next to that. In addition, the first back piece 30 has a head piece 32. Armrests 34 that can be swiveled between a lifted-up position as shown or a position in which they are put down (see FIGS. 2B and 2C) are attached to the sides of the support structure 22 or laterally to the first back piece 30. A mechanism can be provided that automatically puts both the armrests 34 and the first seating surface 26 into the lifted-up position that is shown when the seat 20 is not being used. A storage compartment 36 for other items, for instance a life jacket or a rescue kit, is provided in the lower area of the seat 20.

A further state of the seat 20 as per the invention is shown in FIG. 2B in which the first seating surface 26 and the armrests 34 have been put down. This state of the seat 20 can be called the “TTL position” in which the flight attendants are sitting in an upright seat position during taxiing, take-off and landing (TTL). The first back piece 30 serves here as a back support and is upright or vertical in a first position. All of the other parts that are shown correspond to those of FIG. 1.

A third state of the aircraft seat 20 as per the invention is shown in FIG. 2C. This state can be called the “rest position” because the seat 20 constitutes a recliner and it can make lying or sitting that is more comfortable possible for a person. The components and parts that are shown correspond to those of FIGS. 2A and 2B to start with; the first back piece 30 has been put down in a second position and it roughly extends horizontally with respect to a floor. A part of the back side of the first back piece 30 is used as a second seating surface 38. The first seating surface 26 is located under the first back piece 30 and can serve as an additional support for the first back piece 30, and thus make possible a more advantageous distribution of forces or even an elimination of an otherwise customary or necessary support for the distant end of the first back piece 30 with respect to the floor. A second back piece 40, now visible in FIG. 2, is attached between the support structure 22 and the first back piece 30 that can serve as a back support for a person sitting or lying on the seat 20 in this second position of the first back piece 30.

The second back piece 40 has a first flat segment 42 and a second flat segment 44 that are connected to one another via a second segment pivot axle 46 so as to be able to swivel. The first flat segment 42 is attached to the support structure 22 so as to be able to swivel via a first segment pivot axle 48, and the second flat segment 44 is obliquely attached to the first back piece 30 so as to be able to swivel via a third segment pivot axle 50. The second back piece 40 can be closed up or folded via the segment pivot axles 46, 48, 50 because of segments 42, 44 that can be moved relative to one another and, with a vertically positioned first back piece 30, as shown in FIGS. 2A and 2B for instance, can be stowed away, saving space, in an intermediate area between the support structure 22 and the first back piece 30. In one example, the positioning of the two segments 42, 44 with respect to one another can be fixed or latched in place on a manual or automatic basis so that the second back piece 40 can serve as a back support and will offer sufficient stability for that in the position shown here. A further head piece of the second back piece 40 is provided in the upper part of the second back piece 40. The armrests 34 can, as an example, be pulled out or extended via a mechanism so that they project into the seating area of the second seating surface 38 and can therefore serve as armrests for a person in this state of the seat 20. The foot piece 28 is attached to an end of the first back piece 30. That can optionally be done, as an example, via a mechanism that is easy to use. The foot piece 28 can, in one example, be adjustable in terms of its tilt.

FIGS. 3A to 3D show, in a simplified fashion, steps of a conversion of a seat 20 as per the invention from a first position into a second position of a first back piece 30. Only the elements relevant to the description are described here for the purposes of simplification. Otherwise, the structure of the aircraft seat 20 corresponds to that of the embodiments in FIGS. 2A to 2C. In a starting position in accordance with FIG. 3A, a first back piece 30 is in an upright, roughly vertical, position and its lower side is connected to the support structure 22 at the height of the first seating surface 26 so as to be able to swivel. The support structure 22 can, as an example, be fastened to a wall in the cabin and/or can be mounted to a cabin floor 54. Armrests 34 and the first seating surface have been put down. One plane of the first seating surface 26 runs roughly parallel to the cabin floor 54. This position can correspond to a so-called TTL position, for example.

The first back piece 30 can now be moved away from the support structure 22 in an angular movement with its upper part via a fourth pivot axle 56 in the lower part of the first back piece 30. In so doing, a latching mechanism can be provided, for example, that enables the position in accordance with FIG. 3A to be locked in place and that can be released via a lever mechanism with an actuation device 58, for instance, to move the first back piece 30. A part of the second back piece 40 that can be folded out or unfolded when the first back piece 30 is moved down is visible in accordance with FIG. 3B in the space between the support structure 22 and the first back piece 30. The armrests 34 are in a lifted-up position; the first seating surface 26 has been put down.

If the first back piece as shown in FIG. 3C is moved further, first and second flat segments 42, 44 swivel further outwards. The first seating surface 26 is increasingly covered by the first back piece 30 in the vertical direction.

In a second position of the first back piece 30, it runs, as illustrated in FIG. 3D, roughly horizontal or parallel to the cabin floor 54 so that it forms a second seating surface 38. The two segments 42, 44 now form a plane that is suitable for being a back support for a person. A latchable joint 60 can be provided here, as an example, that automatically engages in its end position and can prevent backwards folding or backwards movement of the segments 42, 44 under load. The second back piece 40 has, in one example, an angle of around 45 to 50 degrees with respect to the first back piece 30. A conversion of the seat 20 into the starting position in accordance with FIG. 3A is done in an analogous fashion in reverse order.

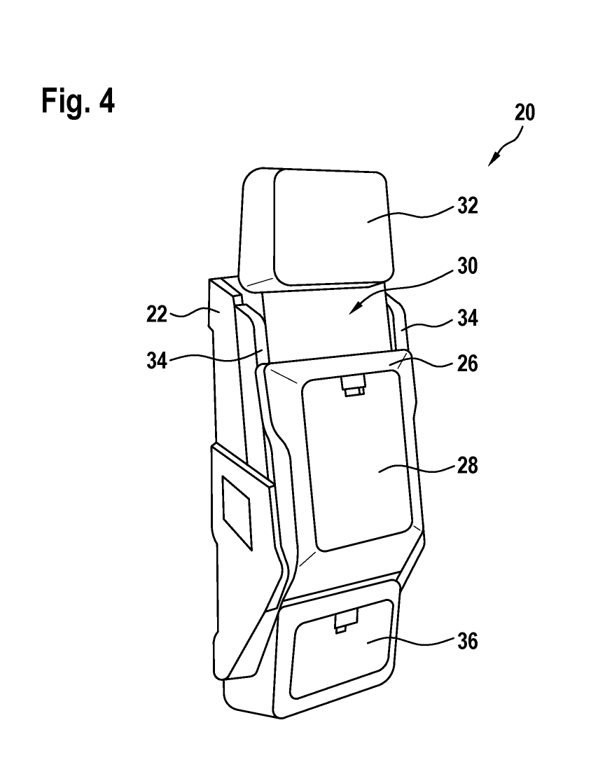

FIG. 4 shows a further example of a seat 20 as per the invention whose elements correspond in principle to the elements described in the examples for FIGS. 2A to 3D. A first seating surface 26 is shown in a closed-up state; the holder for a foot piece 28 that can be attached to the head piece 32 of a first back piece 30 is provided at the bottom or front of the first seating surface. A storage compartment 36 permits, for instance, the storage of a life jacket, rescue kits or other items. A belt system (not show) can be provided for securing the person in all of the variants that are shown.

It is to be pointed out, in addition, that “comprising” does not rule out other elements or steps and “a” or “one” does not rule out pluralities. Furthermore, it is to be point outed that elements or steps that are described with a reference to one of the above examples can also be used in combination with other elements or steps of other examples described above. Reference numerals in the claims are not to be regarded as a limitation.

1. An aircraft seat (20), comprising
a support structure (22),
a first seating surface (26) that essentially extends horizontally and that is attached to the support structure (22),
a first back piece (30),
wherein the first back piece (30) is attached to the support structure (22) so as to be capable of swiveling in a vertical plane around a back-piece pivot axle (56) arranged in the area of the first seating surface (26) so that the first back piece (30) is positioned vertically and forms, in a first position together with the first seating surface (26), a seat for upright sitting of a person and, in a second position, extends horizontally over the first seating surface (26),
wherein the back side of the first back piece (30) turned towards the support structure (22) is designed in such a way that at least a partial area of the back side forms a second seating surface (38) in the second position, and
a second back piece (40) that is arranged between the support structure (22) and the first back piece (30) and that is attached to the support structure (22) at one end and obliquely attached at its other end to the first back piece (30) so that the second back piece (40) forms, together with the second seating surface (38), a recliner for the person in the second position.

2. The aircraft seat (20) according to claim 1, wherein the second back piece (40) comprises
a first flat segment (42) and second flat segment (44),
wherein the first flat segment (42) is attached to the support structure (22) so as to be capable of swiveling around a first segment pivot axle (48) and is connected to the second flat segment (44) so as to be capable of swiveling via a second segment pivot axle (46) at a common edge,
wherein the second flat segment (44) is attached to the first back piece (30) so as to be capable of swiveling around a third segment pivot axle (50), and
wherein the two segments (42, 44) are designed in such a way and the segment pivot axles (46, 48, 50) are arranged in parallel to one another in such a way that the first segment (42) and the second segment (44) are arranged in one plane in back of one another in a second position of the first back piece (30).

3. The aircraft seat (20) according to claim 2, wherein a positioning of the two segments (42, 44) of the second back piece (40) with respect to one another can be fixed in place in the second position of the first back piece (30).

4. The aircraft seat according to claim 2, wherein a length of the first segment (42) and the second segment (44) and the arrangement of the segment pivot axles (46, 48, 50) of the second back piece (40) are chosen in such a way that the first flat segment (42) is essentially arranged in parallel next to the second flat segment (44) in the first position of the first back piece (30).

5. The aircraft seat (20) according to claim 2, wherein an angle between a line perpendicular to the plane of the first back piece (30) and the plane of the first and second segments (42, 44) is between 45 and 50 degrees in the second position.

6. The aircraft seat (20) according to claim 1, wherein a support unit is arranged on the end of the first back piece (30) distant from the support structure (22), said support unit being designed to support the first back piece (30) relative to a floor (54) in the second position.

7. The aircraft seat (20) according to claim 1, further comprising a foot piece (28) that can be attached to the second seating surface (38) at the end of the first back piece (30) that is distant from the support structure (22) or that can be folded out.

8. The aircraft seat (20) according to claim 7, wherein the foot piece (28) can be removed and put into storage in an interior area of the first seating surface (26).

9. The aircraft seat (20) according to claim 7, wherein the first seating surface (26) is detachable from the support structure (22) and can be attached to the first back piece (30) as a foot piece (28).

10. The aircraft seat (20) according to claim 1, wherein the first seating surface (26) can be swiveled in a first position of the first back piece (30) from a horizontal position to a vertical position and connected to an armrest (34) in such a way that it likewise swivels from a horizontal position into a vertical position when the first seating surface (26) is swiveled into the vertical position.
